(19) United States
(12) Patent Application Publication
(10) Pub. No.: US 2010/0211734 A1
(43) Pub. Date: Aug. 19, 2010

(54) MAINTAINING METHOD FOR EXTERNAL CONTROLLER-BASED STORAGE APPARATUS AND MAINTENANCE SYSTEM FOR STORAGE APPARATUS

(75) Inventor: Ching-Chih Chiu, Hsinchu County (TW)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: PROMISE TECHNOLOGY, INC., Hsin-Chu (TW)

(21) Appl. No.: 12/561,762

(22) Filed: Sep. 17, 2009

(30) Foreign Application Priority Data
Feb. 17, 2009 (TW) 098104998

(51) Int. Cl. G06F 12/08

(52) U.S. Cl. 711/114; 711/E12.019

(57) ABSTRACT

The invention discloses a maintaining method for an external controller-based storing apparatus, which the maintaining method includes the steps of: a) connecting a portable maintenance apparatus to an external controller-based storage apparatus; b) when the portable maintenance apparatus is connected to and detected by the external controller-based storage apparatus, executing an application program set automatically; c) gathering system information of the external controller-based storage apparatus; d) analyzing the system information and generating an analytic result; e) loading a maintaining instruction according to the analytic result from the portable maintenance apparatus; and f) executing the maintaining instruction for maintaining the external controller-based storage apparatus.

### BACKGROUND OF THE INVENTION

1. Field of the Invention

The invention relates to a maintaining method and a maintenance system. More particularly, the invention relates to a maintaining method for an external controller-based storage apparatus and a maintenance system for a storage apparatus.

2. Description of the Prior Art

In the digital era nowadays, kinds of data in daily life (e.g. documents, file records, letters, personal information and some multimedia) are usually digitalized. Many important files of personal information, business records or even governmental papers are stored and exchanged depending on some electronic systems. However, the digital storage devices in common personal computers have limited capacities. Besides, these storage devices lack for stability and durability when the storage device are under electricity-failures or attacks from hackers and viruses.

In practical applications, there are many basic and advanced types of external controller-based storage apparatuses, which are usually Redundant Array of Independent Disks (RAID) or storage servers. These storage apparatuses may have independent power supplies and cooperate with independent RAID controller. Accordingly, these storage apparatuses may securely store important files with specific algorithms, and are even capable of recovering the damaged files.

This kind of the external controller-based storage apparatus is widely applied in the government, financial business and personal purpose. For corresponding to different situations, kinds of malfunctions and maintaining demands may occur to the external controller-based storage apparatus. Even though the malfunctions and maintaining demands can be removed or fulfilled by some specific procedures, but the procedures and steps are often too complex for a general user to complete.

In common situation, when an error occurs on the external controller-based storage apparatus at user end, users or customers may report to the engineers (usually Failure Analysis Engineer, FAE) of the producer. Afterward, it may go through a repairing procedure as below:

The FAEs may try to figure out the problem remotely, and they may ask their clients to execute some application programs (e.g. RS-232 console, telnet, some command line programs or some graphic user interface programs). The clients must follow the guide from the FAEs to gather and report system information. The procedure may include dozens of instructions. In some complex situation, the FAEs of the producers must come to the user in person for gathering the system information.

When the system information is gathered, it depends on these FAEs to find out the causes of the malfunctions according to their background knowledge and experience.

Afterward, the external controller-based storage apparatus may be maintained in a way of updating the firmware, reconfiguring the system configuration or resetting the system through the manual operation of the FAEs.

The maintaining method in prior art requires a skilled technician with experience to analyze the problem of the external controller-based storage apparatus and perform corresponding actions, such that it brings a much higher cost on commutation and human resource, besides, it also brings a higher risk of man-made mistakes.

The invention discloses a maintaining method for an external controller-based storage apparatus and a maintenance system for a storage apparatus, to solve aforesaid problems.

### SUMMARY OF THE INVENTION

A scope of the invention is to provide a maintaining method for an external controller-based storage apparatus.

According to an embodiment, the maintaining method includes steps of: (a) connecting a portable maintenance apparatus to an external controller-based storage apparatus; (b) when the portable maintenance apparatus is connected to and detected by the external controller-based storage apparatus, executing an application program set automatically; (c) utilizing the application program set to gather system information of the external controller-based storage apparatus; (d) utilizing the application program set to analyze the system information and generate an analytic result; (e) utilizing the application program set to load a maintaining instruction according to the analytic result from the portable maintenance apparatus; and (f) utilizing the application program set to execute the maintaining instruction for maintaining the external controller-based storage apparatus.

Another scope of the invention is to provide a maintenance system for a storage apparatus. The maintenance system includes a portable maintenance apparatus and an external controller-based storage apparatus. The portable maintenance apparatus stores a maintenance plan include at least one maintaining instruction.

According to an embodiment, the external controller-based storage apparatus includes a transmitting interface and a control unit. The control unit is coupled with the transmitting interface. When the portable maintenance apparatus is connected to the transmitting interface, the control unit executes an application program set automatically according to the plan. The application program set is executed to gather and analyze system information of the external controller-based storage apparatus for generating an analytic result. Afterwards, the application program set loads a corresponding maintaining instruction of the at least one maintaining instruction from the portable maintenance apparatus according to the analytic result and executes the corresponding instruction to maintain the external controller-based storage apparatus.

The application program set includes at least one application program, which can perform analysis or maintenance corresponding to different purposes. The at least one application program can be stored in the external controller-based storage apparatus or in the portable maintenance apparatus. In some other cases, the at least one application program can be partially stored in both of the external controller-based storage apparatus and the portable maintenance apparatus.

Compared with prior art, that the maintaining method for an external controller-based storage apparatus and the maintenance system for a storage apparatus in the invention may utilize a portable maintenance apparatus for carrying the maintaining instructions needed in the maintenance function. It is capable of collecting and analyzing the system information and generating the analytic result of the system error. Accordingly, common users may just connect the portable maintenance apparatus of the invention to the external controller-based storage apparatus, so as to fulfill the maintenance with convenience. The invention may ensure high maintaining efficiency and low cost, and it may also prevent troubles caused by manual mistakes. In this way, it can provide an easy way for recovering or updating an electronic system. A mutual authentication in between and maintenance plan integrity are integrated option in cases when customer application needed to prevent unwilling usage of malicious actions, mistakenly usage or restriction purposes.

The advantage and spirit of the invention may be understood by the following recitations together with the appended drawings.

### BRIEF DESCRIPTION OF THE APPENDED DRAWINGS

FIG. 1A is a function block diagram illustrating a maintenance system for a storage apparatus according to an embodiment of the invention.

FIG. 1B is a schematic diagram illustrating the maintenance system and the application program set in FIG. 1A.

FIG. 1C is another schematic diagram illustrating the maintenance system and the application program set in FIG. 1A.

FIG. 2 is a flowchart illustrating a maintaining method for the external controller-based storage apparatus according to an embodiment of the invention.

FIG. 3 is a flowchart illustrating a maintaining method for the external controller-based storage apparatus according to another embodiment of the invention.

FIG. 4 is a flowchart illustrating a maintaining method for the external controller-based storage apparatus according to another embodiment of the invention.

### DETAILED DESCRIPTION OF THE INVENTION

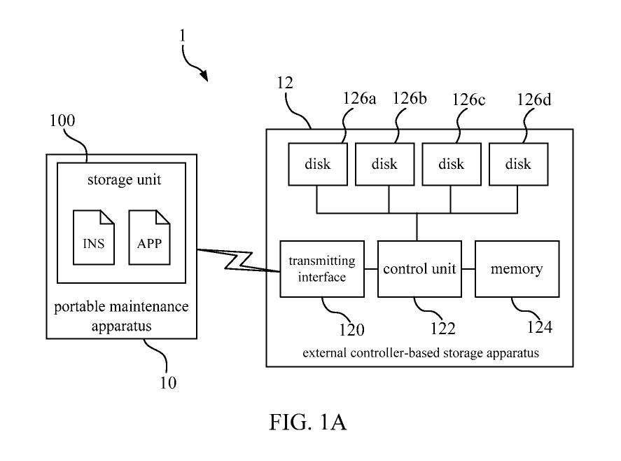

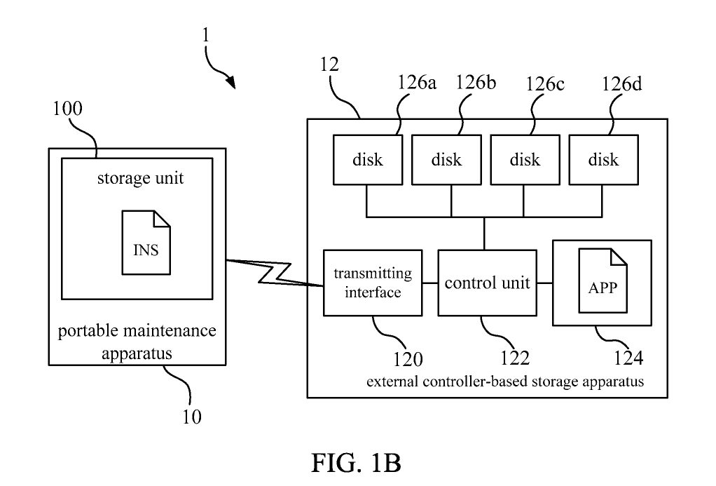

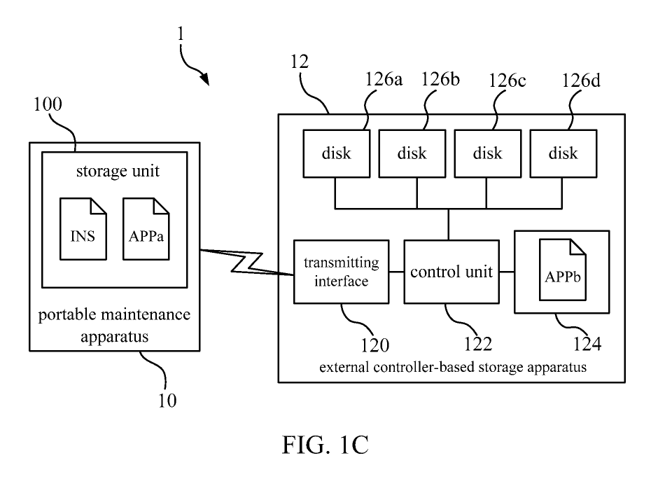

Please refer to FIG. 1A. FIG. 1A is a function block diagram illustrating a maintenance system 1 for a storage apparatus according to an embodiment of the invention. In this embodiment, the maintenance system 1 includes a portable maintenance apparatus 10 and an external controller-based storage apparatus 12. The maintenance system 1 is used for performing an automatic maintenance (recovering, updating, error gathering) on the external controller-based storage apparatus 12.

The portable maintenance apparatus can be a flash disk or a portable hard-disk. In the embodiment, the portable maintenance apparatus includes a storage unit 100. The storage unit 100 stores an application program set APP and maintaining instructions INS.

In this embodiment, the external controller-based storage apparatus 12 can be an external Redundant Array of Independent Disks (RAID) or storage servers. As shown in FIG. 1A, the external controller-based storage apparatus 12, which is an RAID for example, includes a transmitting interface 120 and a control unit 122, a memory 124 and a plurality of disks (as disks 126a-126d shown in FIG. 1A). The total amount of the disks depends on the practical requirement and application of the RAID. The disks are arranged in a redundant array, to elevate the efficiency and stability of the information storage. The detail theories and functions of the RAID are well known by people in the art, and are not repeated here.

The control unit 122 is coupled with the transmitting interface 120, the memory 124 and the disks (disks 126a˜126d). The control unit 122 can be a microprocessor a system-on-chip (SoC) processing unit. The memory 124 is a memory module cooperated with the control unit 122 in computation.

The transmitting interface 120 is used for transmitting data corresponding to the portable maintenance apparatus 10. In the embodiment, the transmitting interface 120, for example, is a universal serial bus (USB) interface. At the same time, the portable maintenance device 10 is a USB flash disk in this embodiment.

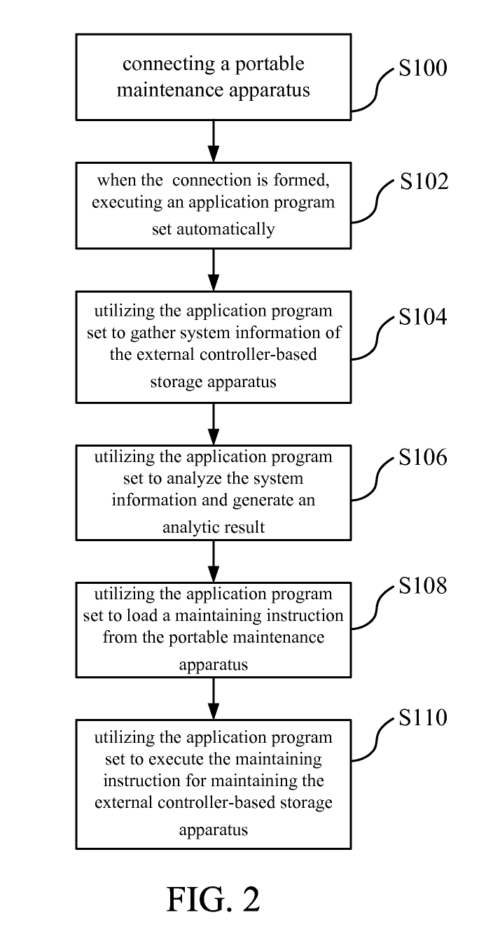

The maintenance system 1 in the invention adopts a maintaining method for an external controller-based storage apparatus. The maintaining method is disclosed in detail as below. Please refer to FIG. 2 as well. FIG. 2 is a flowchart illustrating a maintaining method for the external controller-based storage apparatus 12 according to an embodiment of the invention.

At first, step S100 is performed to connect the portable maintenance apparatus 10 to the external controller-based storage apparatus 12. In the embodiment, the portable maintenance apparatus 10 can be connected to the external controller-based storage apparatus 12 via the transmitting interface 120.

Afterward, when the portable maintenance apparatus is connected to and detected by the external controller-based storage apparatus, step S102 is performed to execute the application program set APP automatically. The application program set APP can be stored in the portable maintenance apparatus 10 in advance (as shown in FIG. 1A), but not limited to this way. Please refer to FIG. 1B and FIG. 1C. FIG. 1B is a schematic diagram illustrating the maintenance system 1 and the application program set APP in FIG. 1A. FIG. 1C is another schematic diagram illustrating the maintenance system 1 and the application program set APP in FIG. 1A. It means that, the application program set APP can also be stored in the external controller-based storage apparatus 12 (as shown in FIG. 1B). In some other cases, part of the application program set (application programs APPa) can be stored in the portable maintenance apparatus 10, and another part of the application program set (application programs APPb) can be stored in the external controller-based storage apparatus 12 (as shown in FIG. 1C).

In this embodiment, the application program set APP is stored in the portable maintenance apparatus 10. When the portable maintenance apparatus 10 is connected to the transmitting interface 120, the control unit 122 reads the application program set APP through the transmitting interface 120, and loads the application program set APP into the memory 124 within the external controller-based storage apparatus 12. Then, the control unit 122 can, but not limited to, execute the application program set APP on the external controller-based storage apparatus 12.

Afterward, step S104 is performed to utilize the control unit 122 driven by the application program set APP to gather system information of the external controller-based storage apparatus 12. The system information in the embodiment can include a system configuration, a system log and system runtime information, which cover detail logs and data of the external controller-based storage apparatus 12 under operating condition.

Afterward, step S106 is performed to utilize the control unit 122 driven by the application program set APP to analyze the system information and generate an analytic result. Afterward, step S108 is performed to utilize the control unit 122 driven by the application program set APP to load a maintaining instruction INS according to the analytic result. Besides, the maintaining instruction INS is read from the portable maintenance apparatus 10. Finally, step S110 is performed to utilize the control unit 122 driven by the application program set APP to execute the maintaining instruction corresponding to the analytic result.

It should be noticed that, the maintaining instruction INS can include an initial condition recovering instruction, a firmware updating instruction and a system repairing instruction.

In another embodiment, the application program set APP includes an encrypted one-time (or limited-time) executable program, such that the application program set APP can only be executed by a certain time. Accordingly, it can elevate the security of the application program set APP with the maintaining instruction INS integrity, such that the application program set APP and the maintaining instruction INS can not be pirated, malicious altered or mistakenly use easily.

The initial condition recovering instruction can be used for resetting the system back to the initial condition. When a client wants to reset his storage apparatus because that a system-level password of the storage apparatus is lost or that the storage apparatus needs to be reassembled, it takes only to insert the portable maintenance apparatus 10 with specific codes (e.g. application program set APP in the embodiment) as a key to the external controller-based storage apparatus 12, and then the system-level passwords or some other specific setting can be reset to the initial condition without manually opening the hardware casing or typing in any commands.

The firmware updating instruction can be used for updating a firmware of the external controller-based storage apparatus 12. The application program set APP can compare the version between a firmware stored in the external controller-based storage apparatus 12 and one stored in the portable maintenance apparatus 10. Then the application program set APP may figure out if the updating is needed, or it may show a notice to users and wait for further commands. A simple confirmation mechanism is introduced by removing and then plugging the same portable maintenance apparatus 10 into the transmitting interface 120 of the external controller-based storage apparatus 12, so as to confirm firmware upgrade operation within a specific period of time. In practical applications, during the specific period of time, the maintenance system 1 may notice the user of the updating request by buzzer sound or blinking display.

Finally, the maintaining instruction INS is executed for maintaining the external controller-based storage apparatus 12. After that the portable maintenance apparatus 10 is connected to the external controller-based storage apparatus 12 in step S100, the application program set APP may automatically perform the information gathering, the information analysis and the apparatus maintenance. Accordingly, it needs no complex manual manipulations to complete the maintenance of the external controller-based storage apparatus 12.

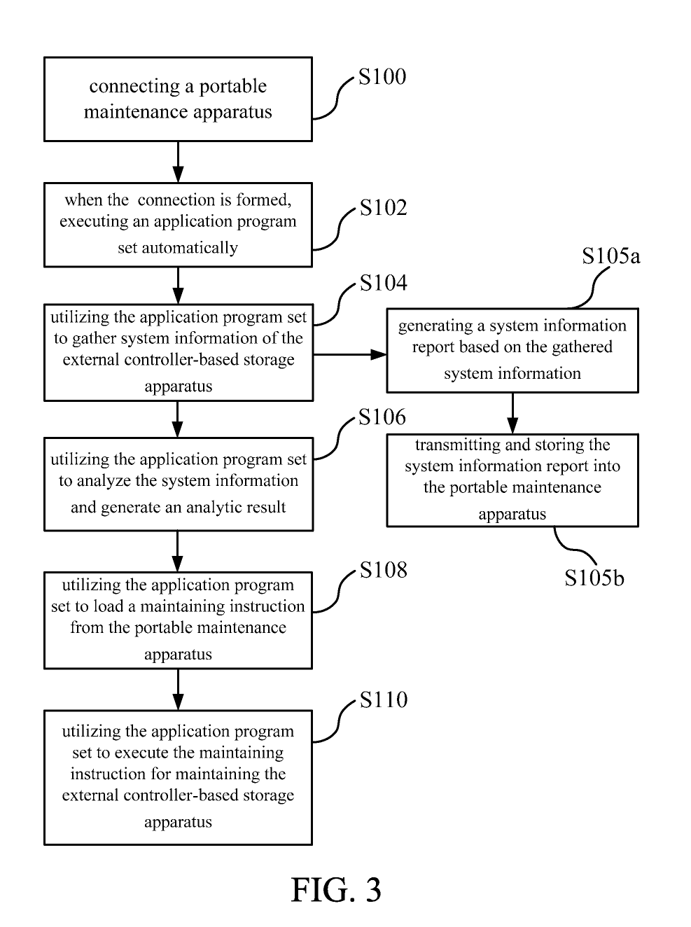

Please refer to FIG. 3. FIG. 3 is a flowchart illustrating a maintaining method for the external controller-based storage apparatus 12 according to another embodiment of the invention. As shown in FIG. 3, the main difference from aforesaid embodiment is that, after step S104 in this embodiment for gathering system information, the maintaining method in this embodiment further perform step S105a to generate a system information report based on the gathered system information. Afterward, step S105b is performed to transmit and store the system information report into the portable maintenance apparatus 10. Accordingly, a common user may easily generate the system information report of the external controller-based storage apparatus 12. When the designer or the service provider need the information about the external controller-based storage apparatus 12 for further estimation, the user may only mail the portable maintenance apparatus 10 (e.g. USB flash disk) or e-mail the gathered information in the portable maintenance apparatus 10 back to the designer or provider. It helps users who are not familiar with complex commands and operations for error estimation.

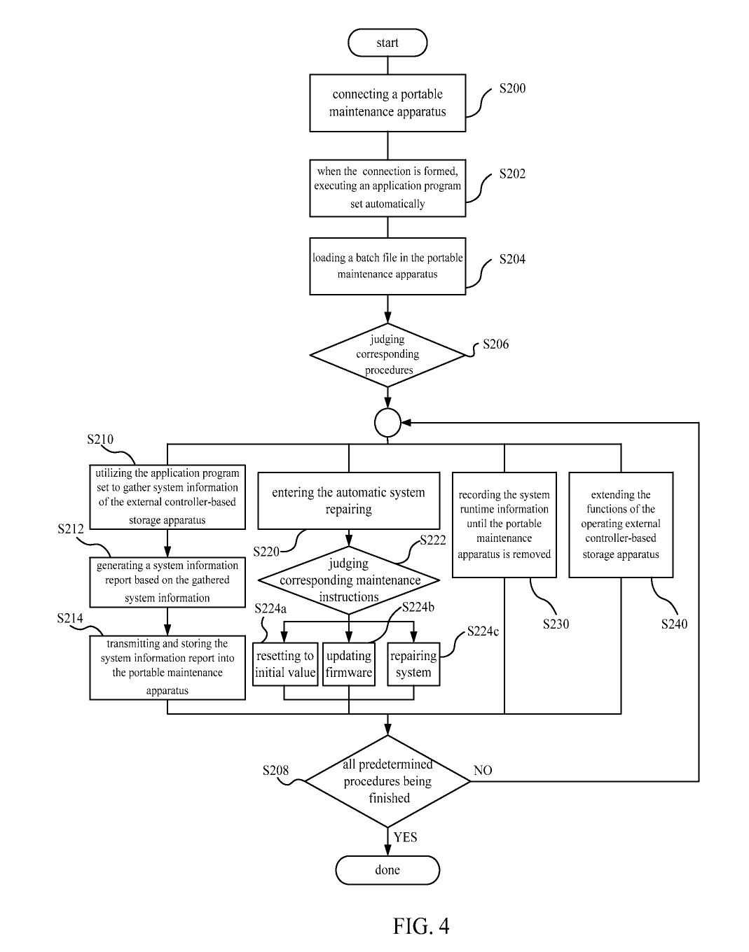

Please refer to FIG. 4. FIG. 4 is a flowchart illustrating a maintaining method for the external controller-based storage apparatus 12 according to another embodiment of the invention. As shown in FIG. 4, step S200 in the embodiment is performed at first to connect the portable maintenance apparatus to the external controller-based storage apparatus.

Afterward, when the portable maintenance apparatus is connected to and detected by the external controller-based storage apparatus, step S202 is performed to execute the application program set APP automatically.

Afterward, step S204 is performed to load a batch file in the portable maintenance apparatus. The batch file may assign the maintenance procedures and maintenance orders, which are needed to be done in this maintenance.

Afterward, step S206 is performed to judge the procedures defined in the batch file, and then accordingly execute one or more procedures from four main processes, which are shown as below:

System information gathering (step S210 to step S214);

Automatic system repairing (step S220 to step S224a, S224b or S224c);

Recording the system runtime information (step S230); and

Extending the functions of the operating external controller-based storage apparatus (step S240).

After aforesaid procedures are finished, step S208 is performed to judge whether every predetermined procedures assigned in the batch file are completed or not. The maintaining method keeps going on until there is no undone procedure, according to the judgment based on the batch file in step S208. The detail theories and functions of the system information gathering and the automatic system repairing are similar to the previous descriptions in the invention, and are not repeated here.

Compared with prior art, that the maintaining method for an external controller-based storage apparatus and the maintenance system for a storage apparatus in the invention may utilize a portable maintenance apparatus for carrying the maintaining instructions needed in the maintenance function. It is capable of collecting and analyzing the system information and generating the analytic result of the system error. Accordingly, common users may just connect the portable maintenance apparatus of the invention to the external controller-based storage apparatus, so as to fulfill the maintenance with convenience. The invention may ensure high maintaining efficiency and low cost, and it may also prevent troubles caused by manual mistakes. In this way, it can provide an easy way for recovering or updating an electronic system.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A maintaining method for an external controller-based storage apparatus, the maintaining method comprising steps of:
connecting a portable maintenance apparatus to an external controller-based storage apparatus;
when the portable maintenance apparatus is connected to and detected by the external controller-based storage apparatus, executing an application program set automatically;
utilizing the application program set to gather system information of the external controller-based storage apparatus;
utilizing the application program set to analyze the system information and generate an analytic result;
utilizing the application program set to load a maintaining instruction according to the analytic result from the portable maintenance apparatus; and
utilizing the application program set to execute the maintaining instruction for maintaining the external controller-based storage apparatus.

2. The maintaining method of claim 1, further comprising steps of:
generating a system information report based on the gathered system information; and
transmitting and storing the system information report into the portable maintenance apparatus.

3. The maintaining method of claim 1, wherein the system information is selected from a group consisting of a system configuration, a system log and system runtime information of the external controller-based storage apparatus.

4. The maintaining method of claim 1, wherein the maintaining instruction is selected from a group consisting of an initial condition recovering instruction, a firmware updating instruction and a system repairing instruction.

5. The maintaining method of claim 1, wherein the application program set comprises an encrypted one-time application program.

6. The maintaining method of claim 1, wherein the external controller-based storage apparatus is an external redundant array of independent disks or a storage server.

7. The maintaining method of claim 1, wherein the portable maintenance apparatus is a flash disk, the external controller-based storage apparatus further comprising a transmitting interface, the portable maintenance apparatus being connected to the external controller-based storage apparatus through the transmitting interface.

8. A maintenance system for a storage apparatus, comprising:
a portable maintenance apparatus storing at least one maintaining instruction; and
an external controller-based storage apparatus comprising:
a transmitting interface; and
a control unit coupled with the transmitting interface, when the portable maintenance apparatus is connected to the transmitting interface, the control unit executing an application program set;
wherein the application program set is executed to gather and analyze system information of the external controller-based storage apparatus for generating an analytic result, afterwards, the application program set loading a corresponding maintaining instruction of the at least one maintaining instruction from the portable maintenance apparatus according to the analytic result and executing the corresponding instruction to maintain the external controller-based storage apparatus.

9. The maintenance system of claim 8, wherein the application program set is stored in the portable maintenance apparatus, when the portable maintenance apparatus is connected to the transmitting interface, the control unit loading through the transmitting interface and executing the application program set.

10. The maintenance system of claim 8, wherein the application program set is stored in the external controller-based storage apparatus.

11. The maintenance system of claim 8, wherein at least one application program of the application program set is stored in the portable maintenance apparatus, when the portable maintenance apparatus is connected to the transmitting interface, the control unit loading the at least one application program through the transmitting interface and executing the application program set.

12. The maintenance system of claim 8, wherein the control unit further generates a system information report according to the gathered system information, the control unit transmitting and storing the system information report into the portable maintenance apparatus through the transmitting interface.

13. The maintenance system of claim 8, wherein the system information is selected from a group consisting of a system configuration, a system log and system runtime information of the external controller-based storage apparatus.

14. The maintenance system of claim 8, wherein the maintaining instruction is selected from a group consisting of an initial condition recovering instruction, a firmware updating instruction and a system repairing instruction.

15. The maintenance system of claim 8, wherein the application program set comprises an encrypted one-time application program and INS.

16. The maintenance system of claim 8, wherein the external controller-based storage apparatus is an external redundant array of independent disks or a storage server.

17. The maintenance system of claim 8, wherein the portable maintenance apparatus is a flash disk.

18. The maintenance system of claim 8, wherein the transmitting interface is a universal serial bus interface and the portable maintenance apparatus is a universal serial bus flash disk.
